(19) United States
(12) Patent Application Publication
(10) Pub. No.: US 2015/0100684 A1
(43) Pub. Date: Apr. 9, 2015

(54) TEST AND MANAGEMENT FOR CLOUD APPLICATIONS

(71) Applicants: Stephane Maes, Fremont, CA (US); Rajeev Bharedhwaj, Saratoga, CA (US); Travis S. Tripp, Fort Collins, CO (US); Vasu Sasikanth Sankhavaram, Santa Clara, CA (US); Arie Zilberstein, Yehud (IL); Dov Tendler, Jerusalem (IL)

(72) Inventors: Stephane Maes, Fremont, CA (US); Rajeev Bharedhwaj, Saratoga, CA (US); Travis S. Tripp, Fort Collins, CO (US); Vasu Sasikanth Sankhavaram, Santa Clara, CA (US); Arie Zilberstein, Yehud (IL); Dov Tendler, Jerusalem (IL)

(21) Appl. No.: 14/391,668

(22) PCT Filed: Jun. 8, 2012
(86) PCT No.: PCT/US2012/041637

§ 371 Date: Oct. 9, 2014

(51) Int. Cl. H04L 12/24; H04L 12/911; H04L 12/26

(52) U.S. Cl. CPC H04L 41/50; H04L 43/08; H04L 47/78
USPC 709/224; 709/223; 709/226

(57) ABSTRACT

A system (100) includes an application model (140) to characterize a given application (110) for deployment on a cloud (130). A deployment manager (120) analyzes an application requirement for the given application (110) based on the application model (140) and policies (150) associated with the given application (110) to substantially match infrastructure resources (160) in the cloud (130) to fulfill the application requirement. A test manager (170) is employed to configure and launch a test suite of application deployments for the given application (110) via the deployment manager (120).

### BACKGROUND

Cloud computing refers to the delivery of scalable and pooled computing, storage and networking capacity as a service to a network of end-recipients. The name comes from the use of clouds as an abstraction for the complex infrastructure of networks and associated hardware operative within the cloud. Cloud computing provides services for a user's data, software and computation over a network, for example. Such computing capability relies on sharing of resources to achieve coherence and economies of scale similar to a utility (like the electricity grid) over a network (typically the Internet). Applications deployed on resources supporting the cloud presently often have to be manually deployed and that consumes considerable administrative time. The manual steps of deploying the application include the provisioning and instantiation of the infrastructure. This requires linking the installation of the application or deployment of an image to the full knowledge of the deployed infrastructure. Manual deployment typically requires numerous sequences of steps usually launched by the user who attempts to deploy the application.

### BRIEF DESCRIPTION OF THE DRAWINGS

FIG. 1 illustrates an example of a system that provides automated test management, staging, and deployment for applications.

FIG. 2 illustrates an example of a test manager interface for automated test and deployment of applications in an environment.

FIG. 3 illustrates an example system for automated deployment and monitoring of applications.

FIG. 4 illustrates an example system utilizing closed loop feedback for deployment and monitoring of applications.

FIG. 5 illustrates a flowchart of an example method for automated deployment of applications.

FIG. 6 illustrates an example deployment system for automated deployment of cloud applications.

FIG. 7 illustrates an example of a deployment manager for matching a resource capability for a cloud with an application requirement of an application.

### DETAILED DESCRIPTION

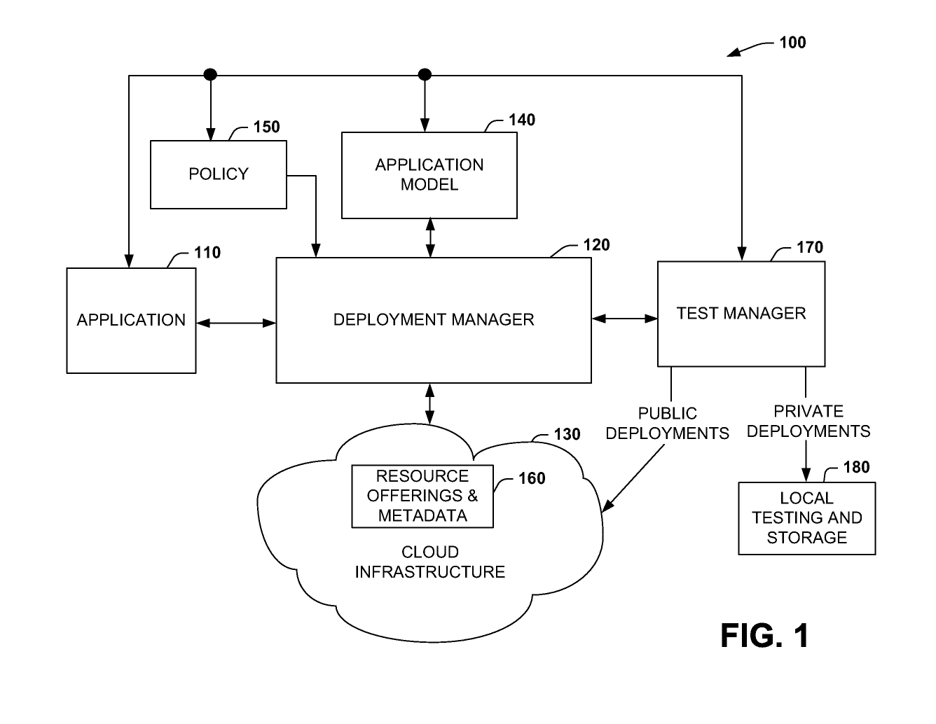

FIG. 1 illustrates an example of a system 100 that facilitates automated test management, staging, and deployment for applications. The system 100 can provide automated deployment and life cycle management of an application 110 by utilizing a deployment manager 120 to determine infrastructure capabilities of a cloud infrastructure 130 (also referred to as cloud 130) and also determining application requirements of the application 110 by analyzing an application model 140 and policy 150. Although a cloud 130 is shown, deployment, staging, and test as described herein can be applied to non-cloud environments as well (e.g., local databases and servers). After such determinations, the deployment manager 120 can automatically manage the lifecycle of the application 110 on the cloud 130, wherein matches are identified (e.g., ideal or best effort—closest match). Based on a measure of closeness in the matching, and/or other policy requirements a match is selected and the infrastructure can be provisioned/instantiated.

After such matching of resources (e.g., an absolute or closest match) to application requirements, then the components of the application 110 can be deployed on the cloud 130 (or non-cloud local execution environment). Infrastructure capabilities of the cloud 130 can be determined via resource offerings and metadata 160 associated with the cloud. For instance, a plurality of service providers supporting the cloud 130 can provide files that specify what types of resources they have available and metadata that describe properties of interest for the respective resource offerings (e.g., resource offering of three servers available with metadata specifying memory size and processor speeds, load (if already instantiated), location, tenancy terms, service level agreements (SLAs), scheduled maintenances, and so forth).

A test manager 170 is provided to configure and launch a test suite of application deployments for the given application 110 via the deployment manager. The test manager 170 can configure a plurality of tests associated to a plurality of different operational deployment scenarios for the application 110. The configuration and resultant application deployments can be administered across organizational boundaries to suit various organizational needs. For example, development may have one set of needs and production may have a separate set of needs. In some cases, public deployments for the application are configured and launched and in other cases, private deployments are launched such as shown via local testing and storage 180. In other cases, a combination of public and private deployments are launched as configured by the test manager 170 and deployed via the deployment manager 120.

The test manager 170 enables automated development testing, development for operations, and application security development, for example, based on determining best matching infrastructure by matching of application models 140 and policies 150 to infrastructure models as specified by the resource offerings and metadata 160. Application models 140 can be specified for specific deployments or tests. When selecting which model to use, this can be achieved via selecting from different models in a set of models or via matching of a label associated to different model types specified in policy, for example. The matching infrastructure can then be employed to test or facilitate production staging while also running various test suites and at different stages of testing (and/or monitoring at production stages). For development testing, the test manager 170 allows developers to follow development of any software with tests in the cloud 130 where they can deploy and run the software in multiple deployment scenarios and execute target test cases without the usual delays and cost to setup deployment and test. After developing and testing of software elements (e.g., applications components), they can then be deployed and operated in production (and monitored similarly). This enables also testing security aspects of the application 110 since security can also be tested in a secure development and production environment such as on the local testing and storage 180. Feedback of bugs, security breaches and other detected events can be easily monitored and fed back (e.g., via monitor components and listeners) to development agents such as for diagnostics and repair. When problems are reported in production, the deployment conditions and context can be reproduced with a bug/problem report for developers (or support) to diagnose and correct) which can then lead to test and patch/updates which can then be staged and/or tested.

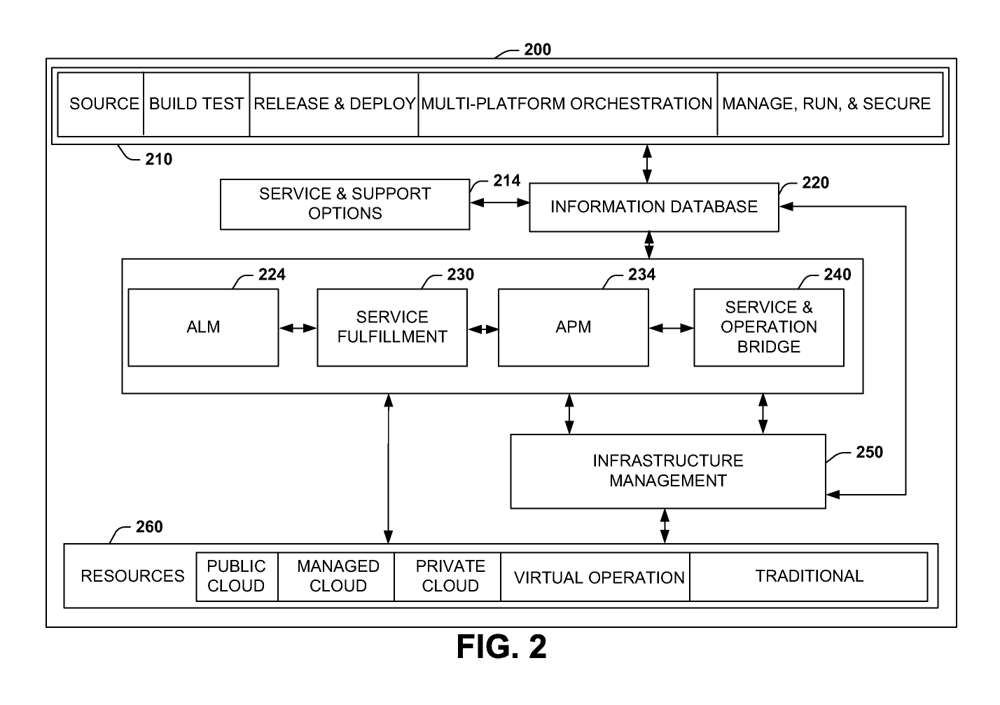

The test manager 170 and deployment manager 120 can be employed to automate testing in accordance with a user interface (UI) (e.g., See FIG. 2) for configuration and launch of test suites on deployments provisioned and deployed by the deployment manager 120. This can include providing automated application programming interfaces (APIs) which can be automated based on monitoring changes in coder repository and launching/running test suites on deployments provisioned and deployed by the deployment manager 120. The deployment manager 120 can be used to move from testing to production which can be initiated by policy changes in terms of location (in production zone) and other production criteria on capacity, delays, quality of service (QoS), and so forth. Other testing scenarios supported by the test manager 170 can include security development, operations development, and quality assurance that can be supported by configured monitoring and closed loop feedback of infrastructure. The results of such development testing for a given application can be utilized by the deployment manager 120 for deployment and lifecycle management for the given application. Continuous integration of application components (e.g., integrated with existing applications they are developed and stored in a repository) can be supported as they are developed based on the deployment manager 120. Continuous delivery of software can also be supported based on the automated actions of the deployment manager 120.

The test manager 170 provides a centralized application management platform for managing and automating within and across application teams and throughout the complete process of developing an application, all within a single workflow. The test manager 170 can support the stakeholders responsible for delivering applications as they progress through their lifecycle. It focuses on the core lifecycle from design through readiness for delivery to operations. This can include requirements management, test planning and functional testing, performance testing, developer management, and defect management. Such application lifecycle activities can be connected together from a workflow perspective with a common management console, layer of project tracking and planning, and built on a common software foundation containing a consistent repository and open integration architecture with a supported software development kit (SDK).

As will be described below with respect to FIG. 2, the test manager 170 can be programmed to support various functions. This can include example functions such as Application Lifecycle Management (ALM) with a unified software platform for accelerating the delivery of secure and reliable applications. This includes development management functions that provide a framework for collaboration among developers, testers and business analysts delivering applications. The test manager 170 can also enable defining, managing and tracking software requirements for respective applications. This can include providing a repeatable, scalable, automatable function to manage technical policy and reusable services, for example. Composite applications are supported via interface components to manage high-quality, reliable, and secure composite applications across the lifecycle. Application lifecycle management includes support for software as a service (SaaS). Quality management functions are also supported for the application and deployment. This includes performance validation where a set of functions are provided to test application performance in project-based scenarios as well as other development modes. Modular testing tools are also provided for quickly developing automated functional test suites for applications.

Using the test manager 170, specified application requirements guide the development of the applications. Application developers and the specified requirements can be stored in memory to guide the setup of test cases and test suites. These are defined in terms configurations, deployments and usage scenarios, for example. The different test cases and scenarios can be captured as applications models 140 and policies 150. Representative deployments can be captured as infrastructure templates. Test suites can be run automatically in target configurations at the push of a button (e.g., via web site that points to templates, models, policies, artifacts and executes the code). Periodically or after changes have occurred with the application, or via manual or scheduled changes, such changes can be automated via the test manager 170, such as calling APIs to pass new artifacts and run the tests. Security tests may also test or enable security challenges at various steps of development. Development operations can be enabled by changing the policies to migrate to a production environment with a selected or determined deployment.

When an application has been deployed based on the matching, the deployment manager 120 further can manage other aspects of the lifecycle of the application. For example, the deployment manager 120 can monitor feedback, and adjust the infrastructure resources based on such feedback. Additionally or alternatively, the deployment manager 120 can dynamically adjust the application model and corresponding policies based on such feedback or other detected events. Similarly, this can also include retiring older versions of application components (e.g., code, middleware (MW), databases, operating system (OS), and so forth) and installing new versions of components to enable continued deployment of the application in the cloud infrastructure 130.

The cloud 130 can be a hybrid such that it can be a combination of traditional Data Centers that are made to behave like infrastructure resources, private clouds (cloud technology developed on premise), public clouds (offered by service providers and managed cloud configurations (managed on premise or in a public cloud/virtual private cloud). As used herein, the term application applies to a collection of components. In addition, the application can be characterized for each of its components by a set of artifacts (e.g., installer, executable, configurations and so forth, and a set of components that are installed and interact with each other (e.g., code, middleware (MW), databases, operating system (OS), and so forth). Also, as used herein, the term determining can include compiling, enumerating, and matching.

As used herein, the term “substantially” is intended to indicate that while the function or results of the term being modified are a desired or intended result that some variation can result. In this context, for example, the term “substantially match” or variants thereof describes a situation that the resulting analysis and comparison is performed to identify resources that are the same; however, in practice the match can correspond to a set of resources that sufficiently similar to enable deployment (identified above as an absolute or best efforts match). Where more than one such set of resources might correspond to a match, the deployment manager can select a best matching set of available resources. Other approaches for selecting such match can be utilized.

The application model 140 can be employed to characterize a given application 110 for deployment on the cloud infrastructure 130, such as though metadata descriptions for various components of the application. The deployment manager 120 can be implemented via instructions executable or data readable by a processor to analyze an application requirement for the given application 110 based on the application model 140 and a policy 150 (or policies) associated with the given application. As will be described below, the policy 150 can be provided to describe additional operating context for the application 110 (e.g., operate application after midnight, use only east coast servers, maintain load balancing between servers, deploy within a given network domain, ensure load is between specified limits on servers, ensure there are no upcoming maintenances within a given window, and so forth as well techniques to “measure closeness” of the matches). The deployment manager 120 can then determine infrastructure resources in the cloud infrastructure sufficient to fulfill the application requirement of the application 110 as specified by the model 140 and policy 150.

In one example, the deployment manager 120 can automatically deploy the given application 110 on the cloud infrastructure 130 after the matching of application requirements of the application 110 to the capabilities of the cloud as specified by the resource offerings and metadata 160. In this type of example, it usually amounts to executing the instructions of other following examples described below (possibly by calling external systems that manage the lifecycle of the infrastructure and/or of the applications). As used herein, the term “application” (e.g., including the application 110) can include a set of components that are to be installed and executed. Examples of such components include multiple tiered logic, user interface (UI), middleware (MW), database (DB), operating system (OS) in addition to the code to install and configure or uninstall such components. Thus, the application 110 refers to these sets of components and artifacts which can also include repositories of such components and artifacts. The application 110 can also be identified by pointers to the components and artifacts including individual pointers or pointers to a set of components. In another example, the deployment manager 120 can generate instructions to inform a system (or user) on how to deploy the given application 110 on the cloud infrastructure 130. In either example, the deployment manager 120 can automatically match requirements of the application 110 as specified by the model 140 and policy 150 with capabilities of the cloud 130 as specified by the resource offerings and metadata 160.

The system 100 utilizes a policy and model-driven approach to automate deployment as opposed to manual procedures of conventional systems. The system 100 can dynamically (or statically) optimize and bind infrastructure resources (characterized by metadata properties) to applications 110 based on models 140 and policies 150 that characterize their requirements in terms of infrastructure properties. This can include matching application metadata to resource metadata as well as taking into account policies and context to automate optimized or preferred/labeled deployment of applications and their components/dependencies on the cloud 130 without also requiring manual deployment steps. In one example, the system 100 allows tracking of instances while also supporting automated management of such instances (e.g., automated monitoring and feedback described below). Different techniques are provided to ingest, author, and design metadata that can also describe infrastructure templates, application models, and policies. Such instances can be stored in a database or repository (not shown) along with the application 110, application model 140, and policy 150.

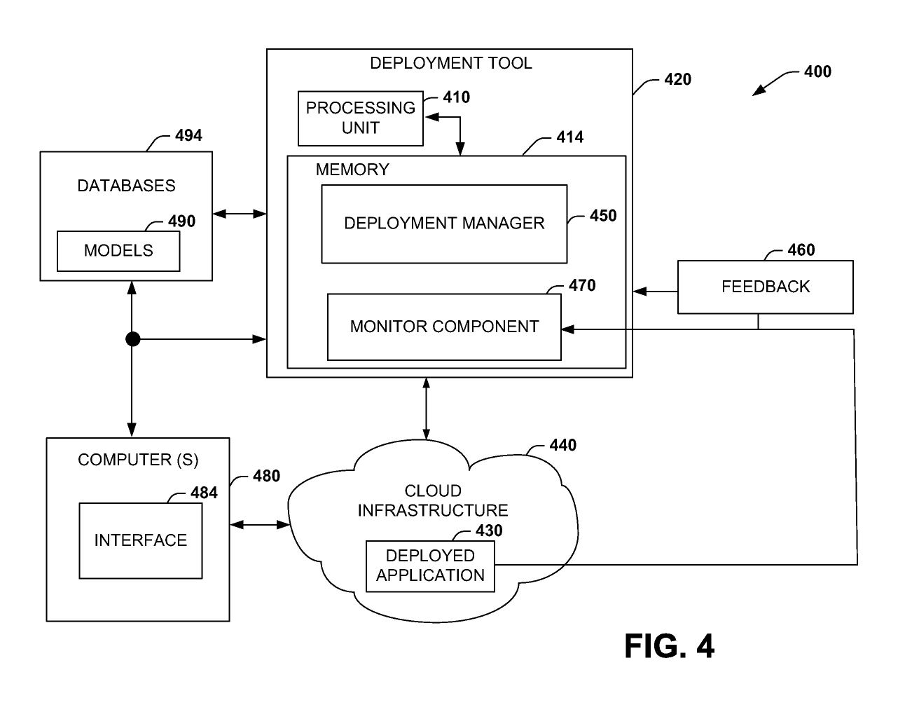

The system 100 can employ closed feedback loops (See FIG. 4) for monitoring applications. Such monitoring applications can be utilized to scale up or scale down an application execution requirement, for example, as well as to notify appropriate recipients, such as users or other system applications. In one example, listeners can be installed in various components to capture events from monitoring. Events received by listeners can trigger handlers that can generate lifecycle management operations on the system 100. Examples of some lifecycle management operations include scale up, scale down, move, de-provision, alert a user or system, and run another executable that may involve composition of the systems described herein and other applications.

The system 100 can be implemented on one or across multiple hardware platforms, wherein the modules in the system can be executed on one or across multiple platforms. Such modules can run on cloud technology (various forms/and hybrid clouds) or offered as a SaaS (Software as a service) that can be implemented on or off the cloud. Complex applications can be automatically deployed on required infrastructure resources without also requiring users to understand how to perform such operations. Policies 150 provide automated instructions for operating guidelines that help administrators mitigate deployment errors. Metadata can also be associated with the application by identifying the type of application (e.g., via UI or API), then the user does not need to understand the application characteristics. This approach allows “best practice”, recommended or imposed deployment models for applications based on their association to metadata.

Policies also allow separating the application characteristics from other contextual considerations (e.g., about user, about application, about infrastructure, about context, about that specific user, about that specific application, and so forth. This facilitates the reuse of the application models across numerous applications. Particularization (e.g., specify a particular set of policies for one application versus another) can also be achieved via policies. This is also how for example the system imposes that a specific set of characteristic values are fixed for a given application or version. For example, the system could apply a generic application model for web applications, yet in another case, explicitly specify a different model or certain values for the attributes of the model. Resources can also be provided from hybrid clouds (e.g., some resources provided from local databases and servers and some resources provided from Internet services).

For purposes of simplification of explanation, in the example of FIG. 1, different components of the system 100 are illustrated and described as performing different functions. However, one of ordinary skill in the art will understand and appreciate that the functions of the described components can be performed by different components, and the functionality of several components can be combined and executed on a single component. The components can be implemented, for example, as computer executable instructions, hardware (e.g., an application specific integrated circuit or a processing unit), or as a combination of both. In other examples, the components could be distributing among remote devices across a network. In one example, topologies can be defined where an applications template can include a topology model of which components should be deployed (e.g., what component to be deployed at which location). In another example, the deployment manager 120 could be provided with a topology model and then determine the best infrastructure resources to match it. In yet another example, after provisioning of the resources and deployment of the application components, a topology instance can be created. The topology instance can be stored and used for later management, monitoring, as disclosed herein.

FIG. 2 illustrates an example of a test manager interface 200 (also referred to as interface 200) for automated test and deployment of applications in a cloud environment. The interface 200 includes a selection pane 210 that enables source code modifications and design, building and lunching of test suites, release and deployment options, multi-platform orchestration (e.g., synchronizing events between application components), and managing, running, and securing application environments. Such selection panes as described herein can also be exposed to other applications via an applications programming interface (API), for example. Service and support options 214 include service governance (e.g., financial agreements, capacity, vendor information, and so forth). Service marketplace options in the service and support options 214 include service stores, product stores, catalog requests to fulfillment, usage data, and chargeback information. A support hub in the options 214 can include case exchanges and application management details. The options 214 can also include collaborative case management such as reporting and tracking of incidents, problems, defects, requirements, changes, and release data for the application. An information database 220 can store/exchange data to/from each of the components described herein with respect to the interface 200.

An application lifecycle manager 224 can include options for designing, modeling, building, and testing application including composite or hybrid applications. A service fulfillment component 230 enables service design composition and fulfillment, application modeling, deployment, and workload management, along with infrastructure design and fulfillment. An application performance module (APM) enables performance testing, analytics, and sizing of the deployed applications. A service operation and bridge component 240 enables event processing, monitoring, analytics, and reporting along with interaction with a real time service model (RTSM) repository. An infrastructure management component 250 provides options for defining/searching system components, network components, and storage components. This includes options for processing/analyzing faults, analyzing application, network, and/or system performance, and providing various configuration interfaces for configuring the options. A resources pane 260 includes options for specifying how applications are to be deployed including options for deployment on public clouds, managed clouds, private clouds, virtual operation, and traditional deployments (e.g., according to a standard deployment scenario).

The interface 200 and associated test manager described herein (e.g., test manager 170 of FIG. 1) enable development testers and security developers to have full automation for the deployment of applications for test and associated test suites. This includes model-based automation, which further facilitates and accelerates the development process. The interface 200 facilitates the creation of models and configurations to be employed therewith. This can include hybrid delivery model where testing can be on private cloud, public cloud, or testing can be partially on private and public cloud (e.g., burst when test capacity requires (e.g., for load testing). Testing can be automatically moved from private clouds to public cloud and conversely.

Operations developers are also provided full automation for the deployment of applications from development and testing to production. This includes full automation of the life cycle management under operation. Model-based automation enables building and reusing models created from similar applications and/or used at development and testing. This also includes testing of hybrid delivery models including public and/or private cloud deployments and testing as previously described. This can include monitoring the source repository to detect changes and to launch tests automatically. This can also include options for periodic, manual and scheduled testing, as well.

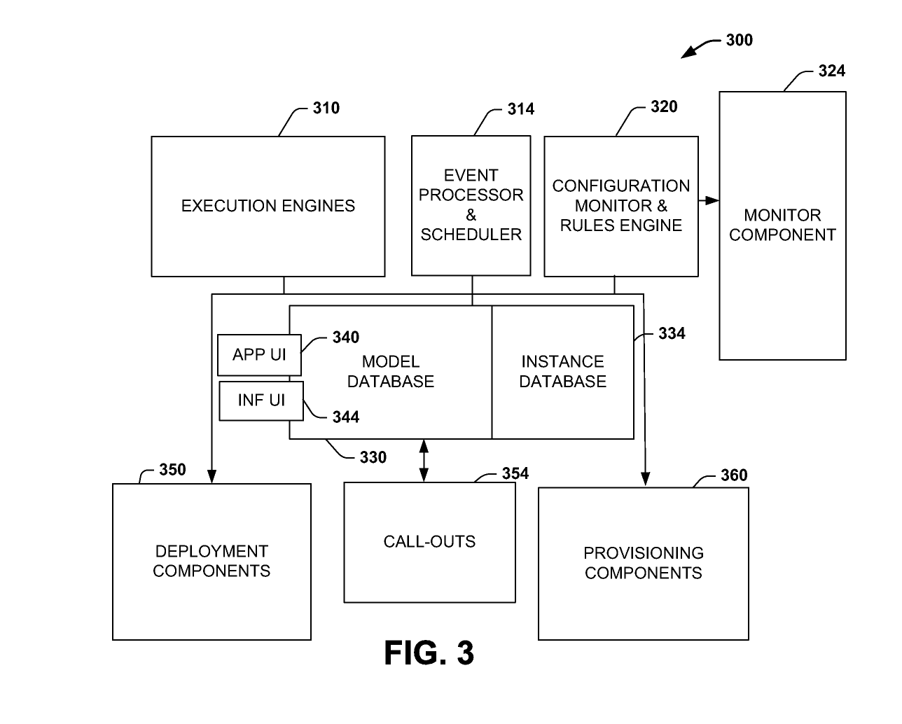

FIG. 3 illustrates an example system 300 for automated deployment and monitoring of applications. The system 300 includes execution engines 310 for automated deployment of applications. Such engines can also include provisioning managers for establishing service level agreements with service providers and can include the deployment manager described above. An event processor and scheduler can 314 can be utilized for processing application events and scheduling tasks associated with the application. As disclosed herein, listeners/handlers can be defined and installed for monitoring events. This can include scheduling the provisioning/deployment and follow-up lifecycle management operations (e.g. tonight or deploy for next 2 weeks). A configuration monitor 320 and rules engine can be employed for configuring a monitor component 324 which provides feedback from an application and for applying rules and policies for executing the application. The system 300 includes a model database 330 that can include application models, infrastructure models, and artifact pointers, for example.

An instance database 334 can be employed to store realized target instances of the application. An application user interface 340 can be employed to design the application and configure metadata for operating the application, whereas an infrastructure user interface 244 can be employed to specify infrastructure requirements for deploying the application in the cloud. Deployment components 350 can include a deployment application programming interface (API) and instructions such as may be specified via a deployment recipe, for example. One or more call-outs 354 can specify customized operating instructions for a given application. Provisioning components 360 can include a provisioning API and plug-ins for interacting with various cloud infrastructure components.

The system 300 can be utilized as a designer tool to build/deploy infrastructure and application templates. It also allows application developers, testers, or other administrators or designers to build application models. Similarly, they can design policies and rules for execution and deployment of an application. Some or all of the infrastructure and application data can be ingested into the repositories shown as database 330 and 340, respectively. Alternatively, such infrastructure or application data can be passed via APIs. Application artifacts (code, executable, installation packages, and the like) can be also ingested or referred to via the databases or API's. The APIs or portal user interfaces 340 and 344 can be used to associate or upload requests to match and deploy while also specifying application templates and policies to use, for example. Such APIs and user interfaces can be implemented as part of a designer tool to define metadata and associate the metadata to infrastructure (e.g., via infrastructure templates and topologies).

Preparation and setup of agent and monitoring tools/can be provided such that applications can discover the instances (which have been instrumented and with agents if needed). This can be achieved via instruction/recipes utilized to deploy infrastructure and application elements after binding the application and its associated components to the infrastructure resources. Events/reports allow closed feedback loops that can be used to scale up/scale out (based on policy) or update context/policies for future changes if allowed by policies as well as notify appropriate parties or systems (See FIG. 4 and description below). As noted above, clouds and resource pools can be hybrid entities where some resources are served locally and some remotely. For clouds or hardware resources that can support auto-scaling, workload management and handling of assurance/monitoring events, the application can be self managed. Such self management, for example, utilizes feedback to determine performance, alter application requirements, and generate alerts as appropriate.

FIG. 4 illustrates an example system 400 utilizing closed loop feedback for deployment and management of applications in a cloud infrastructure. The system 400 includes a processing unit 410 (or processor) that executes instructions from a memory 414 that includes firmware or other storage media for storing computer executable instructions associated with a computer. The processing unit 410 and memory 420 can be provided as part of a deployment tool 420 that deploys an application 430 on a cloud infrastructure 440 via a deployment manager 450. As shown, feedback 460 is received from the deployed application 430 and processed by a monitor component 470. Such feedback 460 can be status or events from the deployed application 430 which indicate how the application is executing. In one example, the feedback 460 can be employed to adjust operating parameters of the deployed application 430, which have been set according to previously determined application requirements. For instance, a foreground task may be adjusted such that the task operates over a differing number of milliseconds than presently being executed. This can include scaling up or down operating requirements of the deployed application 430. In another example, the feedback 460 may be employed to adjust operating infrastructure of the cloud infrastructure 440. For example, service level agreements may be automatically renegotiated with cloud infrastructure service providers to increase or decrease available resources to properly meet operating needs of the deployed application 430.

A computer 480 can operate one or more interfaces 484 to program application models 490 and stored in databases 494. The computer can also interact with the deployment tool 420 to alter deployment and facilitate lifecycle management of applications. The interfaces 484 can also configure infrastructure templates, alter operating requirements, configure the monitor component 470, and interact with events and alerts that are generated within the system 400. As noted previously, along with being executed on the cloud, the deployed application 430 can be spread across unrelated clouds or provided as part of a hybrid application. For example, the deployed application 430 could be executed in part on the cloud infrastructure 440 and in part on the databases 494 which are a different entity (e.g., local server databases versus network databases) than the cloud.

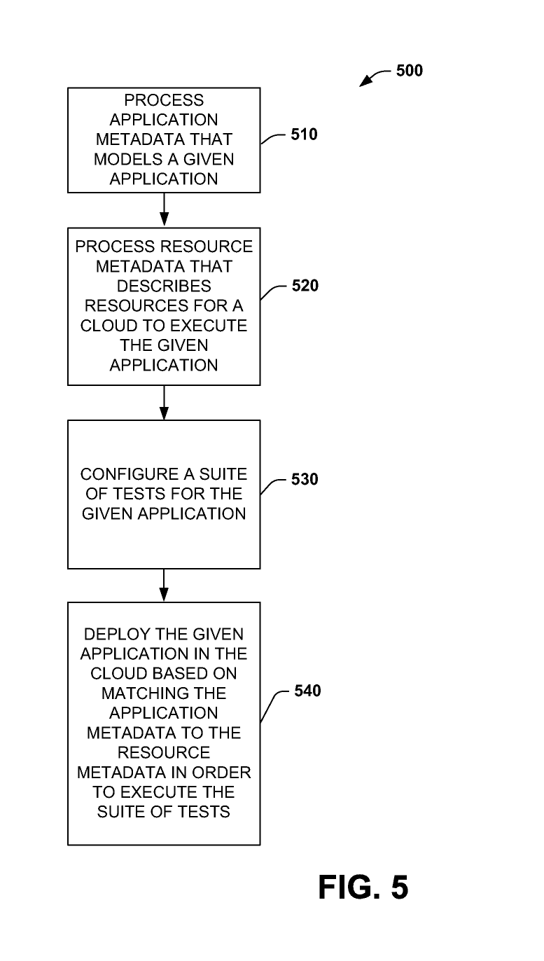

In view of the foregoing structural and functional features described above, an example method will be better appreciated with reference to FIG. 5. While, for purposes of simplicity of explanation, the example method of FIG. 5 is shown and described as executing serially, it is to be understood and appreciated that the present examples are not limited by the illustrated order, as some actions could in other examples occur in different orders and/or concurrently from that shown and described herein. Moreover, it is not necessary that all described actions be performed to implement a method. The example methods of FIG. 5 can be implemented as machine-readable instructions that can be stored in a non-transitory computer readable medium, such as can be computer program product or other form of memory storage. The computer readable instructions corresponding to the method of FIG. 5 can also be accessed from memory and be executed by a processor (e.g., a processing unit 410 of FIG. 4).

FIG. 5 illustrates an example method 500 for automated deployment of applications. At 510, the method 500 includes processing application metadata that models a given application (e.g., via deployment manager 120 of FIG. 1). The method 500 includes processing resource metadata that describes resources for a cloud to execute the given application at 520. At 530, the method 500 configuring a suite of tests for the given application (e.g., via test manager 170 of FIG. 1). At 540, the method 500 includes deploying the given application in the cloud based on matching the application metadata to the resource metadata in order to execute the suite of tests. The method 500 can also include automatically deploying the given application on at least one of a public or private cloud. The method 500 can also include monitoring changes for the given application in a repository and automatically launching a suite of tests based on detection of the changes. The method 500 can also include automating changes by passing new application artifacts and running tests on the new application artifacts in a periodic manner, after changes have occurred with the given application, via manual changes, or via scheduled changes. The method can also include staging the given application in a first environment and moving the given application to at least one other environment.

The method 500 can be automatically executed as part of a system such as the example depicted in FIG. 1 or 4. The system can include a memory for storing computer executable instructions associated with a computer and a processing unit for accessing the memory, executing the computer executable instructions, and thereby performing the method 500. The computer executable instructions can include an application model stored in the memory to characterize a given application for deployment on a cloud infrastructure, wherein the application model can be described by application metadata. A deployment manager stored in the memory can analyze the application metadata for the given application and a policy associated with the given application to determine infrastructure resources in the cloud infrastructure. The infrastructure resources can be specified as resource metadata. The deployment manager can automatically substantially match (e.g., identify a closest match) the application metadata with the resource metadata to fulfill an application requirement. A test manager can be stored in the memory to configure and launch a test suite of application deployments in the cloud for the given application via the deployment manager. A monitor component can monitor test conditions from deployment of the given application in the cloud and to provide feedback for the given application corresponding to the monitored test conditions.

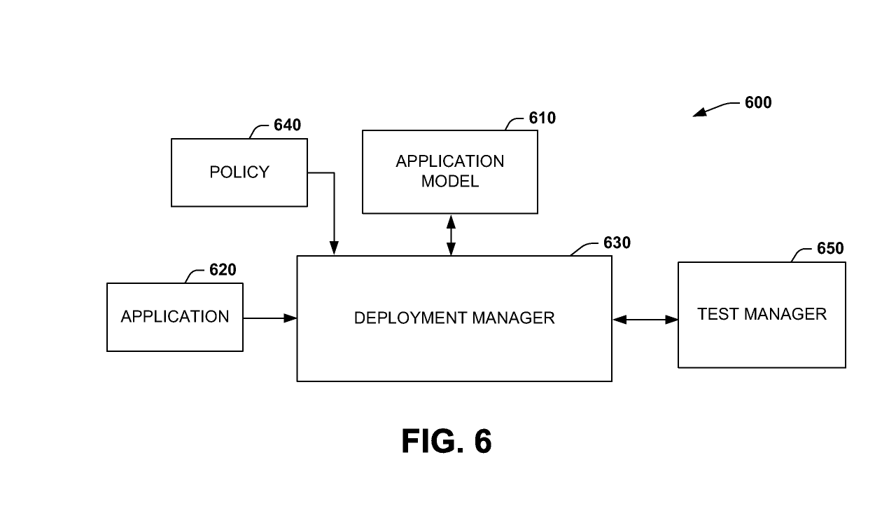

FIG. 6 illustrates an example deployment system 600 for automated deployment of cloud applications. The system 600 includes an application model 610 to characterize a given application 620 for deployment on a cloud infrastructure such as shown above with respect to FIG. 1. A deployment manager 630 analyzes an application requirement for the given application 620 based on the application model 610 and a policy 640 associated with the given application to determine infrastructure resources in the cloud infrastructure to fulfill the application requirement. A test manager 650 can configure and launch a test suite of application deployments for the given application via the deployment manager.

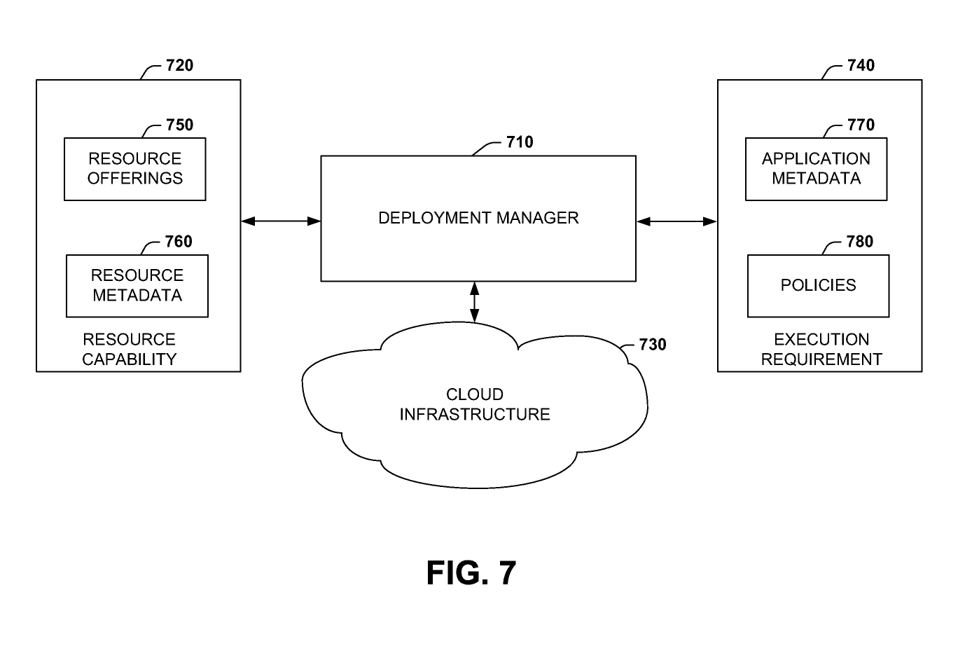

FIG. 7 illustrates an example of a deployment manager 710 for matching a resource capability 720 for a cloud 730 with an application requirement 740 of an application. The resource capabilities 720 can include resource offerings 750 that can be from a pool of resource offerings provided by a plurality of resource providers that support the cloud 730. Such resource offerings can include one or more of cloud services (e.g., accessible via corresponding application program interfaces (APIs)), existing systems that can activate and provision such services, or existing external compositions (parameterized workflow/composition script with functions calls), for example. The resource offerings 750 can be compiled by/ingested from resource providers. The resource capability 720 also includes resource metadata 760 associated to each resource offering that characterize properties of interest of the resource. For example, such metadata 760 can specify location/topologies (e.g., for composite resources), hardware, CPU, memory, operating system included or supported, other software aspects, and labels among other specifications, capacities, SLAs, scheduled maintenances, workload (if already in partial use).

The resource metadata 760 can be associated to any resource designed or added to the resource pool by the resource design or ingestion process. Metadata describing the applications models and resource offerings can be captured via a designer (e.g., a tool, Portal UI or APIs) to describe the metadata. Metadata including recipes (e.g., corresponding to instructions for deployment and other lifecycle management functions such as un-deployment and monitoring) can constitute resource templates. The resource metadata 760 and the associated resource offerings 750 that are specified by the metadata can be provided as part of a template (e.g., data file of metadata and offerings) that can be utilized by other applications.

The application requirement 740 of the given application can be specified via application metadata 770 that can be defined at or after application design. This can include components to be individually deployed (e.g., multiple applications in multiple tiers). The application metadata 770 can also specify requirements/preferences on resources. This can include generic deployment scripts as workflow or processes (asynchronous or synchronous). The deployment scripts can further include deployment instructions for each component (e.g., script to run on allocated resource, instruction to services, and so forth). This can include associated instructions to deploy agents or prepare for monitoring and/or management. Instructions can be applied across components. In general, the application metadata 770 can represent the application models described above with respect to FIG. 1. A given application model can be stored in memory and utilized by multiple applications to facilitate deployment thereof. As noted previously, an application can include a plurality of cooperating components and artifacts (e.g., sources or executable and installable) provided with the applications that are utilized by the deployment scripts.

As shown, additional policies 780 can be provided that apply to the application/Infrastructure and refer to context for operating an application. For example, a policy may specify a location for an application (e.g., only operate on east coast servers), a time (e.g., operate after midnight and before 6:00 AM), a processing requirement (e.g., processing speed and memory needs specified), and/or a load balancing requirement (e.g., no server is to operate with over 50% load), SLAs, availability requirements (e.g. no scheduled maintenance within next x days etc), security (e.g. a particular network domain or security domain).

Applications can be deployed by the deployment manager 710 by retrieving the associated metadata 770 and matching resource offerings 750 available in the pool of resources based on best match (can be exact labeling if for example imposed by policies). Matching of resource metadata 760 to application metadata 770 can be according to strict specifications (e.g., processors must operate at 1 GHZ) or can be matched according to threshold specification (e.g., any processor operating over 500 MHZ is acceptable). Thus, matching can be absolute matching or can be substantial matching where the matching is best fit or close to the desired match criteria. Recipes can be processed by the deployment manager 710 and refer to the code/artifact to use for application deployments. Such recipes can be made available via a known repository location or referred to via a pointer to the recipe, for example. Topologies of composite resources that correspond to an application can be saved as a new resource type by the deployment manager 710 for reuse when similar application metadata is used by another application, for example. Multiple releases of the same applications or similar applications can reuse the same application metadata but, for example, with different policies to relate to operating context.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A system comprising:
an application model, stored in memory, to characterize a given application for deployment on a cloud;
a deployment manager, corresponding to instructions executable by a processor, to analyze an application requirement for the given application based on the application model and policies associated with the given application to substantially match infrastructure resources in the cloud to fulfill the application requirement; and
a test manager, corresponding to instructions executable by the processor, to configure and launch a test suite of application deployments for the given application via the deployment manager.

2. The system of claim 1, wherein the deployment manager is to automatically deploy the given application on the cloud based on a command from the test manager.

3. The system of claim 1, further comprising an application programming interface (API) to monitor application changes in a repository and launch the test suite of application deployments via the deployment manager.

4. The system of claim 1, further comprising a user interface to configure and launch the test suite of application deployments via the deployment manager.

5. The system of claim 4, wherein the user interface is further to command the deployment manager to move the given application from testing to production.

6. The system of claim 5, wherein the user interface is further to enable policy changes to at least one of specify a destination location for the move of the given application, specify a capacity for the given application, or specify a quality of service (QoS) for the given application.

7. The system of claim 4, wherein the user interface provides interface options to configure the test suite of application deployments for at least one of a developments test environment, a development security environment, a development operations environment, or a quality assurance environment.

8. The system of claim 4, wherein the user interface includes a selection pane that includes a source code selection user interface element, build test selection user interface element, a release and deploy selection user interface element, a multi-platform orchestration selection user interface element, and a manage, run, and security selection user interface element.

9. The system of claim 4, wherein the user interface includes a resources pane that include configuration function options for a public cloud, a private cloud, a managed cloud, a virtual operation, and a traditional configuration.

10. The system of claim 4, wherein the user interface includes at least one of an automated lab manager to design, model, and build test components, a service fulfillment component for service design, application modeling, workload management, and infrastructure design, a service and operations bridge for configuring events, performance, and analytics, or an infrastructure management component to manage faults, performance, and configuration of the infrastructure resources in the cloud.

11. A method comprising:
processing, by a computer, application metadata to model a given application;
processing, by the computer, resource metadata to describe resources for a cloud to execute the given application;
configuring, by the computer, a suite of tests for the given application; and
deploying, by the computer, the given application in the cloud based on matching the application metadata to the resource metadata in order to execute the suite of tests.

12. The method of claim 11, further comprising automating changes by passing new application artifacts and running tests on the new application artifacts in a periodic manner, after changes have occurred with the given application, via manual changes, or via scheduled changes.

13. The method of claim 11, further comprising staging the given application in a first environment and moving the given application to at least one other environment.

14. A system, comprising:
a memory for storing computer executable instructions associated with a computer; and
a processing unit for accessing the memory and executing the computer executable instructions, the computer executable instructions comprising:
an application model stored in the memory to characterize a given application for deployment on a cloud, wherein the application model is described by application metadata;
a deployment manager stored in the memory to analyze the application metadata for the given application and policies associated with the given application to determine infrastructure resources in the cloud, wherein the infrastructure resources are specified as resource metadata and the deployment manager automatically matches the application metadata with the resource metadata to fulfill an application requirement; and
a test manager stored in the memory to configure and launch a test suite of application deployments in the cloud for the given application via the deployment manager.

15. The system of claim 14, further comprising a monitor component to monitor test conditions from deployment of the given application in the cloud and to provide feedback for the given application corresponding to the monitored test conditions.
